(19) United States
(12) Patent Application Publication
(10) Pub. No.: US 2024/0119541 A1
(43) Pub. Date: Apr. 11, 2024

(54) FARMING USING TOPOGRAPHY SUNLIGHT EXPOSURE DISTRIBUTION ANALYSIS

(71) Applicant: INTERNATIONAL BUSINESS MACHINES CORPORATION, ARMONK, NY (US)

(72) Inventors: Atul Mene, Morrisville, NC (US); Michael Boone, Lutz, FL (US); Tushar Agrawal, West Fargo, ND (US); Jeremy R. Fox, Georgetown, TX (US); Sarbajit K. Rakshit, Kolkata (IN)

(21) Appl. No.: 18/045,561

(22) Filed: Oct. 11, 2022

(51) Int. Cl. G06Q 50/02; G06Q 30/02; G06V 20/10; G06V 20/13

(52) U.S. Cl. CPC G06Q 50/02; G06Q 30/0206; G06V 20/13; G06V 20/176

(57) ABSTRACT

A method is provided for identifying topography in a locality. The topography includes horizontal surfaces and vertical surfaces. Sunlight exposure incident to the identified topography is identified. The intensity of the identified sunlight exposure and variation over time is analysed. Crop types for growing on the topography based on the analysed intensity of sunlight exposure and variation over time are identified.

### BACKGROUND

Exemplary embodiments of the present inventive concept relate to farming, and more particularly, to farming using topography sunlight exposure distribution analysis.

Farming is a challenging endeavour that often involves narrow margins of profit, evolving consumer preferences, and high stakes for global food security in the backdrop of an ever-expanding global population. Thus, there is no room for tolerating uncontrolled variables. Weather and climate conditions play an important role in determining the efficiency of crop production. Farm management practices have thus emerged that involve farming in controlled environments to control for climate and weather conditions. Greenhouse farming is one of the basic variations of farming in a controlled environment. Greenhouse farming is the unique farm practice of growing crops within sheltered structures covered by a light permeable material. The main purpose of greenhouses is to control for weather and climate and prevent damage from various pests.

### SUMMARY

Exemplary embodiments of the present inventive concept relate to a method, a computer program product, and a system for farming using topography sunlight exposure distribution analysis.

According to an exemplary embodiment of the present inventive concept, a method is provided for identifying topography in a locality. The topography includes horizontal surfaces and vertical surfaces. Sunlight exposure incident to the identified topography is identified. The intensity of the identified sunlight exposure and variation over time is analysed. Crop types for growing on the topography based on the analysed intensity of sunlight exposure and variation over time are identified.

According to an exemplary embodiment of the present inventive concept, a computer program product is provided for farming using topography sunlight distribution analysis. The computer program product includes one or more computer-readable storage media and program instructions stored on the one or more non-transitory computer-readable storage media capable of performing a method. The method includes identifying topography in a locality which includes horizontal surfaces and vertical surfaces. Sunlight exposure incident to the identified topography is identified. The intensity of the identified sunlight exposure and variation over time is analysed. Crop types for growing on the topography based on the analysed intensity of sunlight exposure and variation over time are identified.

According to an exemplary embodiment of the present inventive concept, a computer system is provided for farming using topography sunlight distribution analysis. The system includes one or more computer processors, one or more computer-readable storage media, and program instructions stored on the one or more of the computer-readable storage media for execution by at least one of the one or more processors capable of performing a method. The method includes identifying topography in a locality which includes horizontal surfaces and vertical surfaces. Sunlight exposure incident to the identified topography is identified. The intensity of the identified sunlight exposure and variation over time is analysed. Crop types for growing on the topography based on the analysed intensity of sunlight exposure and variation over time are identified.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 illustrates a schematic diagram of computing environment 100, which may include farming using topography sunlight distribution analysis program 150, in accordance with an exemplary embodiment of the present inventive concept.

FIG. 2 illustrates a flowchart of farming using topography sunlight distribution analysis 200, in accordance with an exemplary embodiment of the present inventive concept.

FIG. 3 illustrates a block diagram of the system of farming using topography sunlight distribution analysis 200, according to an exemplary embodiment of the present invention.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION

Exemplary embodiments of the present inventive concept are disclosed hereafter. However, it shall be understood that the scope of the present inventive concept is dictated by the claims. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present inventive concept according to various exemplary embodiments.

While greenhouse farming has largely mitigated the negative influence of unpredictable weather, pests, and climate on crop production, there exists an unaddressed impetus to transition farming to more localized crop production. Customers are increasingly seeking fresher vegetables, faster deliveries, and less storage burden despite more frequent purchases. However, many localities (e.g., urban environments) are presently not suited to crop production and delivery. Consequently, many localities still import their food from considerable distances away. However, long-distance food import entails a larger transport expense and carbon footprint, potential mismatches with local consumer demand, and risk of crop spoilage en route to consumers. The present inventive concept provides for farming using topography sunlight distribution analysis which can be used to tailor distributed farming to a locality, and thus enhance customer satisfaction and efficiency while putting unused surfaces to productive use.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as farming using topography sunlight distribution program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

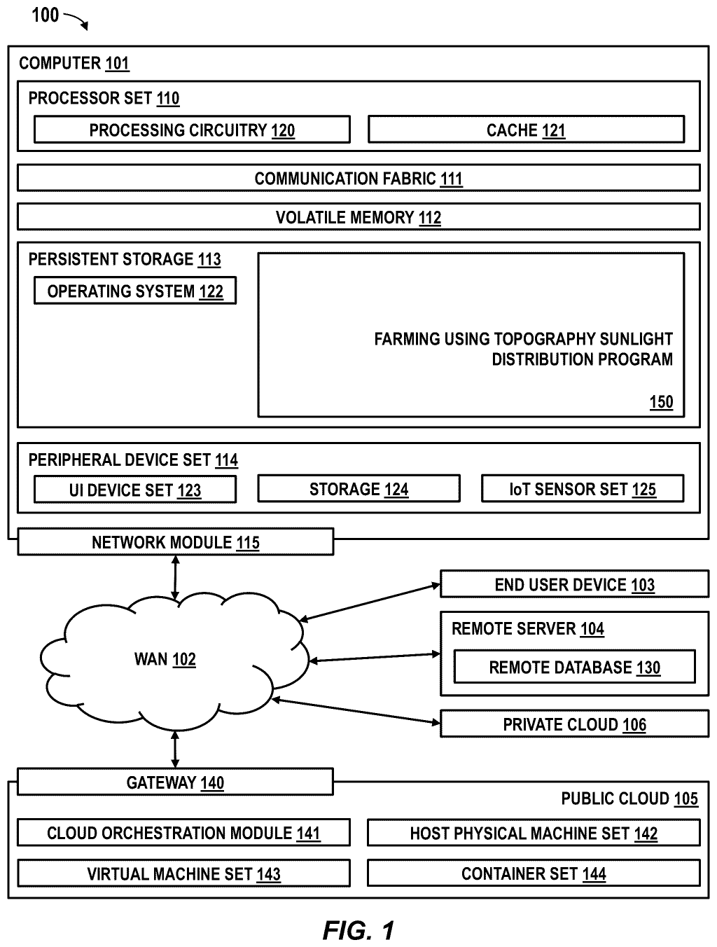

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

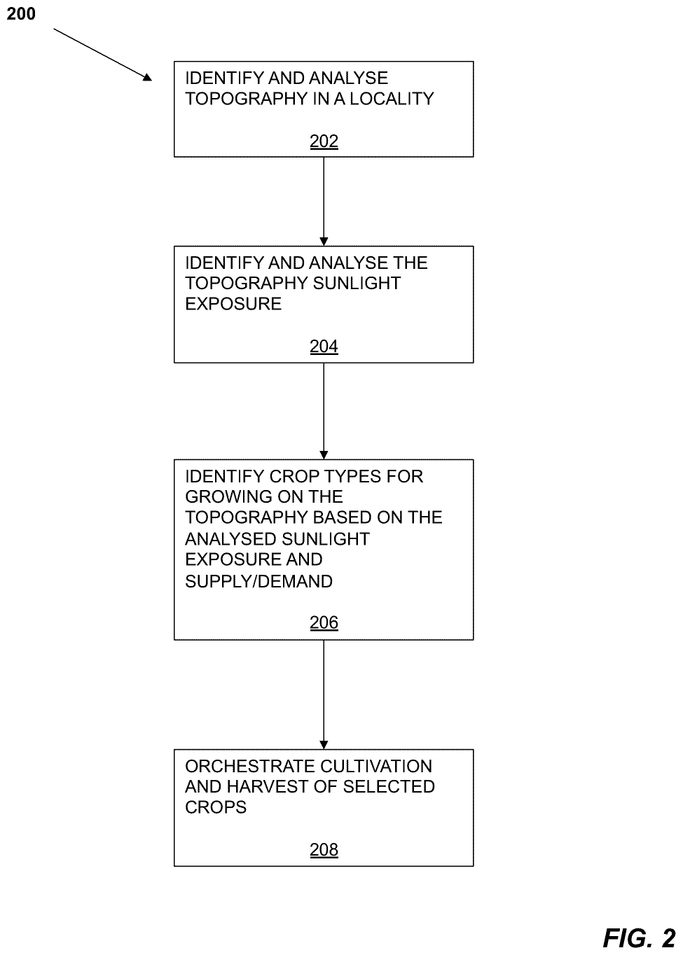

FIG. 2 illustrates a flowchart of farming using topography sunlight distribution 200, in accordance with an exemplary embodiment of the present inventive concept.

The farming using topography sunlight distribution program 150 may identify and analyse topography in a locality (step 202). The locality may refer to a bounded area enclosed by, for example, a circumference, perimeter (e.g., blocks), custom boundary, city, town, neighbourhood, etc. The locality may be at least partially populated. A user may select the locality for topography identification by name/neighbourhood (e.g., New York City, Manhattan, Manhattan Financial District, etc.) or manually input/draw the bounded area. The topography within a locality may include various manmade structures (e.g., buildings, awnings, protruding ornate elements, balconies, water tanks, bridges, support pillars of bridges, etc.) and natural features (e.g., rock faces, hill/mountain summits, open pastures, etc.). The farming using topography sunlight distribution program 150 may have a user interface. Users may include producers (e.g., farmers); vendors (e.g., grocers); lessors/lessees and/or sellers/buyers of topography space; and/or customers (e.g., consumers).

The farming using topography sunlight distribution program 150 may analyse at least one source of multimedia and identify the locality topography and features thereof. The multimedia may be obtained by the user or automatically retrieved via the network (e.g., keyword search for topography terms and the locality). The sources of multimedia may include manmade structure blueprints, government records, titles, user input topographical feature dimensions, locality maps (e.g., topographical, general reference, global positioning system (GPS), etc.), absolute positions of topographical features (e.g., GPS coordinates, physical addresses, etc.), area surveys, CAD drawings, written descriptions of topographical features (e.g., Wikipedia, Encyclopaedia, etc.) and/or images thereof (e.g., IoT perspective images, network-retrieved images, and satellite imaging, etc.). In an embodiment, a plurality of IoT cameras may be connected to a “smart city” and the farming using topography sunlight distribution program 150. The IoT cameras may provide imaging to the farming using topography sunlight distribution program 150 automatically, and at predetermined intervals or continuously.

The obtained multimedia of the topography may be subjected to machine learning processes (e.g., computer vision, natural language processing (NLP), etc.) to extract topographical features, such as at least a portion of the manmade structures/the natural features, structure types, ownership characteristics thereof (e.g., abandoned vs. presently used, public vs. private, individual vs. entity owned, owner submitted externally exposed surface lease and/or sale, etc.), and viability characteristics (e.g., prior/planned renovations, manmade structure/natural feature age, landmark status, material types, manmade structure/natural feature type, externally exposed surfaces, orientations/dimensions thereof, etc.). Identified manmade structures/natural features/miscellaneous objects (e.g., streetlamps) of known dimensions in obtained images may also be used to determine relative proportions, scaling, and dimensions for adjacent identified manmade structures and/or natural features.

The farming using topography sunlight distribution program 150 may identify externally exposed surfaces of the manmade structures and/or natural features, their physical attributes (e.g., orientations relative to the ground, dimensions, planar direction faced (east, west, south, north), etc.) and their role of inclusion in the identified manmade structures (e.g., lateral building walls, awnings, balconies, support structures, building roofs, etc.). In an embodiment, the externally exposed surfaces may be virtually divided into a plot array (e.g., a grid) of units (e.g., minimum units, greenhouse units, predetermined dimension units, user apportioned units, mixed size/shape units, etc.). The plot array and/or annotations of identified physical attributes may be overlay on imaging of the topographical features for user visualization. Each plot array unit may be included in a blockchain/ledger, such as for sale or lease by the owner of respective topographical features. Manmade structure and/or natural feature owners endeavouring to sell or lease externally exposed surface space may opt-in with the farming using topography sunlight distribution program 150 via user input.

For example, several building owners throughout New York City opt-into sale and/or lease of their externally exposed surfaces for farming purposes. Building owner 1 allocates only half of a building 1 roof for sale and/or lease. Building owner 2 submits the entire roof of a building 2 for sale and/or lease. Building owner 3 offers the lateral, rear, top quarter of a building 3 (commercial) and its associated unused balcony for sale and/or lease. The topography sunlight distribution program 150 obtains satellite imaging of the roofs of buildings 1 and 2, and nearby IoT imaging of the building 3 portion using the owner given addresses. Building owners 1 and 2 manually input their roof dimensions but building owner 3 neglects to enter the dimensions of his offered space. The topography sunlight distribution program 150 obtains the dimensions of the space by comparison of building 3 to the recognized Chrysler building of known dimensions, also depicted adjacently in obtained images. The topography sunlight distribution program 150 may then generate a virtual grid array for each building's offered externally exposed surfaces which is overlay on the respective imaging.

The farming using topography sunlight distribution program 150 may identify and analyse the topography sunlight exposure (step 204). The farming using topography sunlight distribution program 150 may be connected to various apparatuses for measuring sunlight exposure, such as via a network (e.g., a smart city). Sunlight exposure measurements may include reflected sunlight, incident sunlight, and/or heat (e.g., to the entire externally exposed surface and/or units thereof), and/or may be approximated based on adjacent manmade structures and/or natural features, location, orientation, direction faced, and historic weather/climate/pollution data for the locality. Light exposure measurements may be obtained by imaging and analysis (e.g., global satellite image recognition, optical object recognition, infrared, etc.), light-based sensors (e.g., photodetector, photodiode, IoT detected photosynthetically active radiation, etc.), photometry, radiometry, etc. over a predetermined period (e.g., hours, days, months, seasons) and/or under variable weather conditions (e.g., high pollution, overcast, partly cloudy, clear, etc.). The farming using topography sunlight distribution program 150 may determine the degree of sunlight exposure and the variation across time (e.g., morning vs. evening, fall vs. spring, etc.). The farming using topography sunlight distribution program 150 may identify shifts in sunlight patterns over periods and the dynamic variations in sunlight exposure under variable weather conditions. Annotations describing dynamic sunlight exposure and visual intensity demarcations (e.g., colour density of varying opacity) may be overlay on the respective images for user visualization. In an embodiment, each unit of externally exposed surface represented in the blockchain/ledger may have an initial price suggested based on the respective sunlight exposure and available grid units in the locality, or the price may be designated/modified by the owner.

For example, returning to the above example in New York City, the farming using topography sunlight distribution program 150 accesses satellite imaging of buildings 1 and 2 and the IoT cameras with a vantage of the offered externally exposed surface space of building 3 and analyses the respective sunlight exposure. For each grid unit, the topography sunlight distribution program 150 may indicate the associated measurement of sunlight exposure. Building 1 is adjacent to an industrial district and experiences heavy pollution during the early afternoon, thus resulting in the lowest sunlight exposure measurements. Building 3 has sunlight exposure partially diminished by the shadow cast by adjacent skyscrapers and additionally faces east, resulting in an intermediate sunlight exposure. Building 2 is in a residential part of Queens, the roof is above the treeline, and does not compete with skyscrapers nor does it experience heavy pollution, thus making it the most valuable externally exposed surface.

The farming using topography sunlight distribution program 150 may identify potential crop types for growing on the topography based on the analysed sunlight exposure and supply/demand (step 206). The farming using topography sunlight distribution program 150 may receive/retrieve information regarding user crop preferences in the locality which may be period dependent (e.g., seasonal). The farming using topography sunlight distribution program 150 may include machine learning analysis of consumer data, such as anonymous information on consumer spending habits (e.g., in the locality, region, generally, etc.), user (e.g., vendor or individual) historic user purchases/orders/requests, and/or manual user inputs. The farming using topography sunlight distribution program 150 may determine crops in demand for the locality from the analysed consumer data and learn therefrom. A hierarchy of crop preferences may also be determined. Based on each identified crop in in demand for the locality, the farming using topography sunlight distribution program 150 may reference a learned internal database (if already available) and/or may receive/retrieve information regarding requisite and/or optimal growing conditions (e.g., sunlight, water, carbon dioxide, pollutant sensitivity, etc.) for demanded crops.

The farming using topography sunlight distribution program 150 may compare ambient locality conditions (e.g., sunlight, rain, atmospheric moisture, carbon dioxide, pollutants, etc.) with respective requisite and/or optimal crop growing conditions (e.g., sunlight, water, carbon dioxide, pollutant sensitivity, etc.). The comparison may be based on cultivation duration and/or a harvest date range. With respect to the requisite and/or optimal sunlight exposure requirement of a demanded crop, the farming using topography sunlight distribution program 150 may compare the analysed sunlight distribution for the various externally exposed surfaces of the locality topography to determine whether a match exists. If a match exists, the farming using topography sunlight distribution program 150 may then determine whether use of that externally exposed surface(s) is viable (e.g., modification cost to cure requisite and/or optimal condition deficit, exceeds threshold of crop loss risk given narrow qualification of water and/or sunlight, sufficiency of available space, distance from identified consumer users, externally exposed surface sale and/or rental cost, structural integrity/age informing ability to support greenhouse units and/or planters, cost of installation/maintenance versus predicted crop yield and consumer demand, etc.). The initial price of externally exposed surfaces may be modified or generated based on locality demanded crops, externally exposed surface supply/demand/availability, projected crop yields, and/or viability.

For example, the farming using topography sunlight distribution program 150 receives anonymized vendor and producer purchase histories from locality-based grocery stores as well as consumer inputs. The farming using topography sunlight distribution program 150 analyses the obtained information and determines that the greatest consumer demand in the locality is for tomatoes, squash, and blueberries. The farming using topography sunlight distribution program 150 references a learned catalogue of growing conditions, including daily sunlight exposure requirements for each of blueberries, squash, and tomatoes. Squash has the highest sunlight exposure requirement and thus can only be grown on the roof of building 2. Tomatoes have a moderate sunlight exposure requirement and thus may be grown on the roof of building 3. Blueberries have the lowest sunlight exposure requirement and thus may be grown on the proffered externally exposed surfaces of building 1. Although tomatoes can be grown more securely on building 2, the estimated or actual cost of externally exposed surface units exceeds a stipulated margin of return input by a producer, but may be chosen nonetheless by an eager consumer.

The farming using topography sunlight distribution program 150 may orchestrate the cultivation and harvest of the selected crops (step 208). The farming using topography sunlight distribution program 150 may receive/retrieve/reference information regarding ripening periods for each demanded crop. The farming using topography sunlight distribution program 150 may learn the effect of variations in requisite and/or optimal growing conditions for the demanded crops and determine the influence thereof on the ultimate ripening date and make predictions accordingly. The farming using topography sunlight distribution program 150 may also use computer vision to evaluate ripeness of crops and problems (e.g., pest infiltration, plant diseases, indications of wilting, etc.). The farming using topography sunlight distribution program 150 may deploy a robot (e.g., wheeled, with the capacity for flight, etc.) to harvest crops determined to be ripened and/or authorize/schedule a user owned robot to perform the same. The farming using topography sunlight distribution program 150 may stagger scheduling times for adjacent crops with the same ripening date to avoid collisions and robot traffic. The farming using topography sunlight distribution program 150 may dynamically evaluate requisite crop conditions and learned thresholds of sub-requisite tolerance. Robots may also be deployed to perform crop critical services, such as heating in unusual cold, providing artificial sunlight during an extended overcast period, and/or watering in unusually dry conditions at the election and expense of the user. Costs associated with these crop critical services may be calculated and presented to an interested user. A single robot may perform each of maintenance, cultivation, and transport, or the roles may be separately delegated, such as when a plurality of robots are used. The farming using topography sunlight distribution program 150 may delegate roles to the plurality of robots, such as cultivation dedicated, third-party pickup transfer dedicated robot, and/or direct transport dedicated robot. In an embodiment, the farming using topography sunlight distribution program 150 may exhibit a preference for pairing consumer and vendors with producers and/or externally exposed surfaces that minimize a transport time.

For example, a squash producer has leased the externally exposed space on building 2. Months later, the squash producer receives an order from a locality-based grocer via the farming using topography sunlight distribution program 150 user interface. The producer initiates the deployment of a dedicated robot to harvest the squash from grid units that are determined to be ripened and transfer them to the grocer's drone for pickup upon arrival. Some of the non-ripened grid units, however, have been experiencing sub-requisite sunlight exposure, which is projected to continue for several days based on weather forecasts. The producer may deploy the drone to provide the vulnerable grid units with artificial sunlight for a predetermined period sufficient to preserve the crop viability, provided that the associated expense is approved by the user.

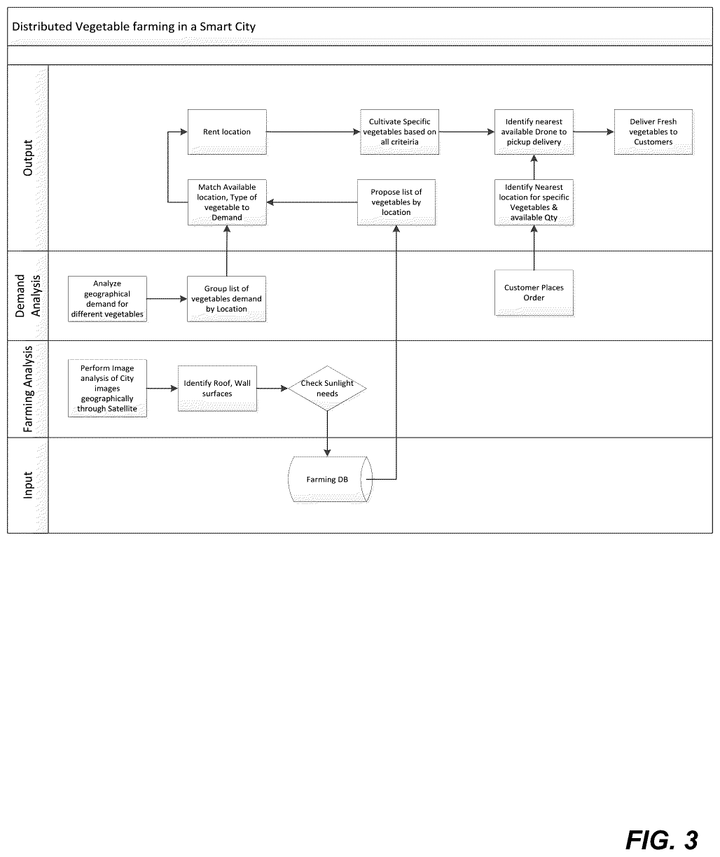

FIG. 3 illustrates the block diagram of the system of farming using topography sunlight distribution analysis 200, according to an exemplary embodiment of the present invention.

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

1. A method for farming using topography sunlight distribution analysis is provided, the method comprising:
identifying topography in a locality, wherein the topography includes horizontal surfaces and vertical surfaces;
identifying sunlight exposure incident to the identified topography;
analysing the intensity of identified sunlight exposure and variation over time; and
identifying crop types for growing on the topography based on the analysed intensity of sunlight exposure and variation over time.

2. The method of claim 1, wherein the locality is an urban environment, and wherein the horizontal surfaces and vertical surfaces belong to man-made structures.

3. The method of claim 1, wherein the identifying crop types for growing is based on local consumer demand.

4. The method of claim 1, wherein the identifying sunlight exposure incident to the topography includes using global satellite image recognition to detect sunlight distribution.

5. The method of claim 1, further comprising:
planting and harvesting the identified crops for growing using a robot capable of flight.

6. The method of claim 1, further comprising:
using a distributed ledger or blockchain utilization to calculate a price for growing the identified crops.

7. The method of claim 1, further comprising:
scheduling a harvest of the identified crop types based on the analysed intensity of sunlight exposure and variation over time, and a predicted cultivation period.

8. A computer program product for farming using topography sunlight distribution analysis, the computer program product comprising:
one or more computer-readable storage media and program instructions stored on the one or more non-transitory computer-readable storage media capable of performing a method, the method comprising:
identifying topography in a locality, wherein the topography includes horizontal surfaces and vertical surfaces;
identifying sunlight exposure incident to the identified topography;
analysing the intensity of identified sunlight exposure and variation over time; and
identifying crop types for growing on the topography based on the analysed intensity of sunlight exposure and variation over time.

9. The method of claim 8, wherein the locality is an urban environment, and wherein the horizontal surfaces and vertical surfaces belong to man-made structures.

10. The method of claim 8, wherein the identifying crop types for growing is based on local consumer demand.

11. The method of claim 8, wherein the identifying sunlight exposure incident to the topography includes using global satellite image recognition to detect sunlight distribution.

12. The method of claim 8, further comprising:
planting and harvesting the identified crops for growing using a robot capable of flight.

13. The method of claim 8, further comprising:
using a distributed ledger or blockchain utilization to calculate a price for growing the identified crops.

14. The method of claim 8, further comprising:
scheduling a harvest of the identified crop types based on the analysed intensity of sunlight exposure and variation over time, and a predicted cultivation period.

15. A computer system for farming using topography sunlight distribution analysis, the system comprising:
one or more computer processors, one or more computer-readable storage media, and program instructions stored on the one or more of the computer-readable storage media for execution by at least one of the one or more processors capable of performing a method, the method comprising:
identifying topography in a locality, wherein the topography includes horizontal surfaces and vertical surfaces;
identifying sunlight exposure incident to the identified topography;
analysing the intensity of identified sunlight exposure and variation over time; and
identifying crop types for growing on the topography based on the analysed intensity of sunlight exposure and variation over time.

16. The method of claim 15, wherein the locality is an urban environment, and wherein the horizontal surfaces and vertical surfaces belong to man-made structures.

17. The method of claim 15, wherein the identifying crop types for growing is based on local consumer demand.

18. The method of claim 15, wherein the identifying sunlight exposure incident to the topography includes using global satellite image recognition to detect sunlight distribution.

19. The method of claim 15, further comprising:
planting and harvesting the identified crops for growing using a robot capable of flight.

20. The method of claim 15, further comprising:
using a distributed ledger or blockchain utilization to calculate a price for growing the identified crops.
